(19) United States
(12) Patent Application Publication
(10) Pub. No.: US 2009/0102808 A1
(43) Pub. Date: Apr. 23, 2009

(54) TOUCH PANEL AND FABRICATING METHOD THEREOF

(75) Inventors: Ping-Wen Huang, Taichung City (TW); Chin-Pei Hwang, Kaohsiung City (TW); Chien-Chung Kuo, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/251,421

(22) Filed: Oct. 14, 2008

(30) Foreign Application Priority Data
Oct. 17, 2007 (TW) 96138844

(51) Int. Cl. G06F 3/041; H01J 9/00

(52) U.S. Cl. 345/173; 445/46

(57) ABSTRACT

A method of fabricating a touch panel is provided. First, a first substrate having a first electrode layer is provided. Then, a sealant is formed on the first substrate, and the sealant surrounds a periphery of the first substrate to define a closed area. Next, a dielectric material is dripped in the closed area. Then, a second substrate having, a second electrode layer is provided. The first substrate and the second substrate are assembled and joined by the sealant, such that the dielectric material fills the closed area to form a dielectric layer between the first substrate and the second substrate. The touch panel has good quality, and the yield rate of the method of fabricating the touch panel is high.

### CROSS-REFERENCE TO RELATED APPLICATION

This application claims the priority benefit of Taiwan application serial no. 96138844, filed on Oct. 17, 2007. The entirety of the above-mentioned patent application is hereby incorporated by reference herein and made a part of this specification.

### BACKGROUND OF THE INVENTION

1. Field of the Invention

The present invention relates to a touch panel structure and a fabricating method thereof. More particularly, the present invention relates to a capacitive touch panel and a fabricating method thereof.

2. Description of Related Art

With the progress of semiconductor industry, digital tools such as mobile phones, personal digital assistants, notebooks, multimedia players, and tablet computers are developed in the trend of more convenience, multi-function, and chic appearance. In recent years, along with the rapid development and application of information technology, wireless mobile communications and information home appliances, many information products adopt touch panels as input devices instead of conventional input devices such as keyboards and mice, so as to realize more convenient, small, light, and humanistic products.

FIG. 1 shows a conventional touch panel. Referring to FIG. 1, the touch panel 100, for example, is a capacitive touch panel, and includes a first substrate 110, a second substrate 120, and a dielectric layer 130 sandwiched between the first substrate 110 and the second substrate 120. The first substrate 110 has a first electrode layer 112, and the second substrate 120 has a second electrode layer 122. The first electrode layer 112 and the second electrode layer 122 may be formed by a plurality of strip electrodes, and the first electrode layer 112 and the second electrode layer 122 extend in different directions and intersect each other. When a user touches the touch panel 100 with a finger or an object (e.g., a touch pen), the touch panel 100 will produce a capacitance change at the position where the finger or the touch pen touches. The capacitance change then is converted into a control signal, so as to enable an information product to perform the functions of playing, displaying, calculating, and the like.

In the conventional touch panel 100, the dielectric layer 130 is often fabricated with an optical adhesive. Thickness of the dielectric layer 130 determines the capacitance between the first electrode layer 112 and the second electrode layer 122, and influences the characteristics of the touch panel 100 as well. Therefore, the dielectric layer 130 between the first electrode layer 112 and the second electrode layer 122 must have a fixed thickness, and preferably may be thinner or thicker according to different requirements. However, the optical adhesive with a thick thickness is difficult to fabricate, so the thickness of the dielectric layer 130 is limited. Moreover, when the first substrate 110 and the second substrate 120 are rigid substrates such as glass substrates, bubbles are often generated when the first substrate 110 and the second substrate 120 are assembled. Therefore, it is difficult to maintain a good quality of the touch panel 100. When the size of the touch panel 100 is larger, the problem is even worse.

### SUMMARY OF THE INVENTION

The present invention is directed to a method of fabricating a touch panel, so as to improve a yield rate of the touch panel.

The present invention is also directed to a touch panel, so as to solve the problems that a thickness of a dielectric layer of the touch panel is difficult to control and that bubbles are generated between two substrates when the two substrates are assembled.

The present invention provides a method of fabricating a touch panel. First, a first substrate having a first electrode layer is provided. Then, a sealant is formed on the first substrate, and the sealant surrounds a periphery of the first substrate to define a closed area. Next, a dielectric material is dripped in the closed area. Then, a second substrate having a second electrode layer is provided. Moreover, the first substrate and the second substrate are assembled and joined by the sealant, such that the dielectric material fills the closed area to form a dielectric layer between the first substrate and the second substrate.

In one embodiment of the present invention, a method of forming the sealant includes a printing process, and the printing process includes screen printing, ink jet printing, offset printing, relief printing, or gravure printing.

In one embodiment of the present invention, a method of forming the sealant includes a dispensing process.

In one embodiment of the present invention, the method of fabricating the touch panel further includes a curing process after the first substrate and the second substrate are assembled, so as to cure the sealant. The curing process includes thermally curing, light curing, UV curing, or a combination thereof.

In one embodiment of the present invention, a method of forming the dielectric layer includes dripping a liquid dielectric material into the closed area, and curing the liquid dielectric material.

In one embodiment of the present invention, the method of fabricating a touch panel further includes forming a plurality of supports on at least one of the first substrate and the second substrate, and the plurality of supports is located in the closed area. In addition, for example, the sealant and the supports may be simultaneously formed.

In one embodiment of the present invention, a method of forming the supports includes spraying a plurality of ball supports in the closed area. In addition, the method of forming the supports may also be a photolithography process, or a dispensing process. Furthermore, the method of forming the supports may also be a printing process, and the printing process includes screen printing, ink jet printing, offset printing, relief printing, or gravure printing.

The present invention also provides a touch panel, including a first substrate, a second substrate, a sealant, and a dielectric layer. The first substrate has a first electrode layer, and the second substrate has a second electrode layer. The sealant is disposed between the first substrate and the second substrate, and defines a closed area with the first substrate and the second substrate. Meanwhile, the dielectric layer is disposed in the closed area.

In one embodiment of the present invention, the first electrode layer includes a plurality of strip electrodes.

In one embodiment of the present invention, the second electrode layer includes a plurality of strip electrodes.

In one embodiment of the present invention, the touch panel further includes a plurality of supports disposed in the closed area. The supports may be a plurality of pillar supports or be a plurality of ball supports. When the supports are the pillar supports, a material of the supports is a photoresist material, a light curable material, or a thermally curable material. When the supports are the ball supports, a material of the supports includes silicon dioxide.

In one embodiment of the present invention, the first substrate, for example, may be disposed between the first electrode layer and the dielectric layer.

In one embodiment of the present invention, the first electrode layer, for example, may be disposed between the first substrate and the dielectric layer.

In one embodiment of the present invention, the second substrate, for example, may be disposed between the second electrode layer and the dielectric layer.

In one embodiment of the present invention, the second electrode layer, for example, may also be disposed between the second substrate and the dielectric layer.

In one embodiment of the present invention, a material of the dielectric layer includes a light curable material, a thermally curable material, or a UV-thermal curable material.

In the present invention, the touch panel fabricated by assembling and joining the two substrates with the sealant can facilitate the maintenance of distance between the two substrates. In detail, in the touch panel, the capacitance between the first electrode layer and the second electrode layer may be adjusted by changing the thickness of the sealant through dispersing appropriate size of spacers in the sealant, so the design of the touch panel of the present invention is more flexible. Moreover, a plurality of supports may be formed in the dielectric layer between the two substrates in the present invention. Therefore, when a size of the touch panel increases, the supports maintain a fixed distance between the two substrates, thereby further ensuring the good quality of the touch panel of the present invention.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional touch panel.

FIGS. 2A to 2D are three-dimensional views of processes of the method of fabricating a touch panel according to an embodiment of the present invention.

FIGS. 3A to 3D are cross-sectional views of processes of the method of fabricating a touch panel according to an embodiment of the present invention.

FIG. 4 is a schematic view of a touch panel according to an embodiment of the present invention.

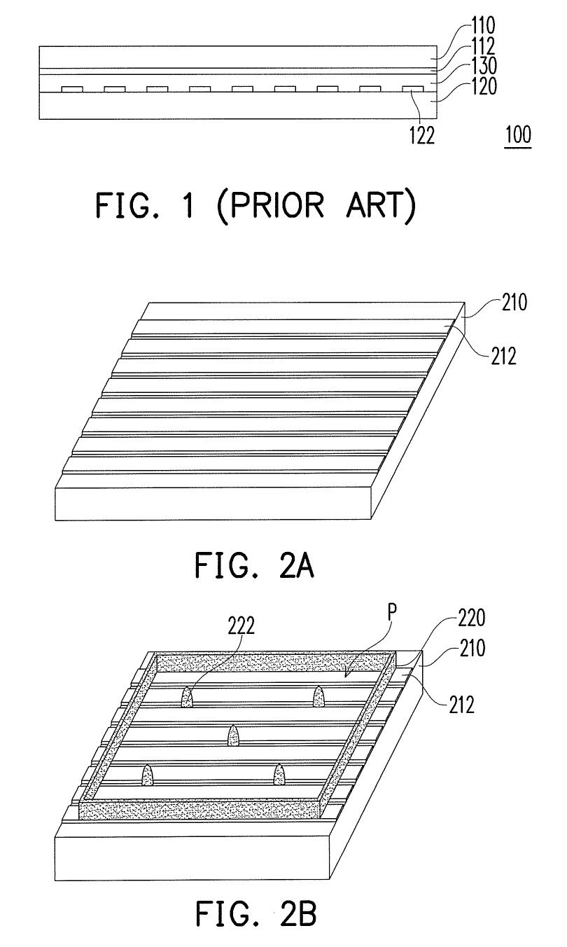

### DESCRIPTION OF EMBODIMENTS

Touch panels may be classified into different types. In a capacitive touch panel, a dielectric layer with an appropriate thickness is disposed between two electrode layers, so as to maintain a fixed capacitance between the two electrode layers. However, it is known from the prior art that in this type of touch panel, the thickness of the dielectric layer is limited by the inherent properties of the dielectric material (e.g., the optical adhesive), and cannot be increased as desired. In other words, when the size of the touch panel increases, the thickness of the dielectric layer is more difficult to control. Therefore, the present invention provides a touch panel fabricated by disposing a sealant between two substrates, so as to maintain the distance between the two substrates. Hereinafter, the method of fabricating a touch panel of the present invention and the touch panel of the present invention will be described for illustrating the present invention. However, the following content is described for illustrating the implementation of the present invention, but is not intended to limit the scope of the present invention.

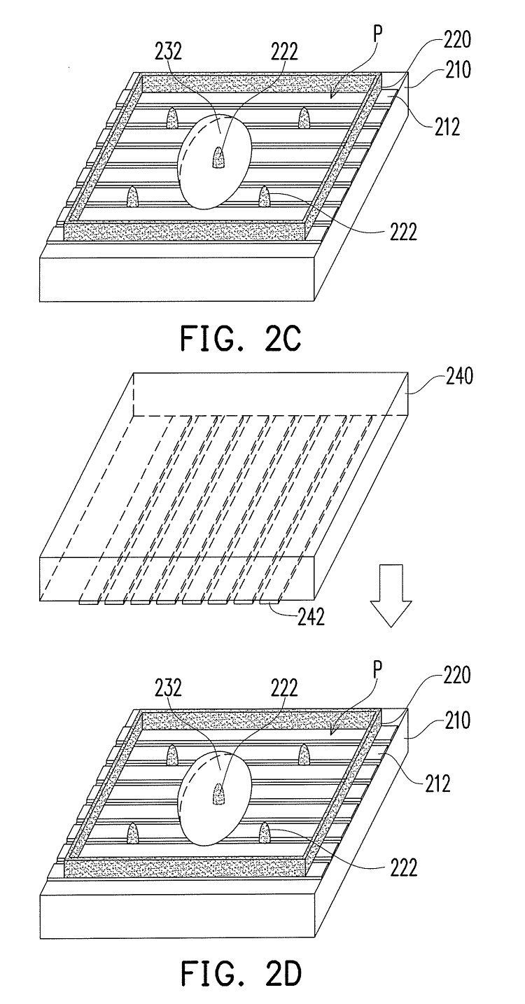

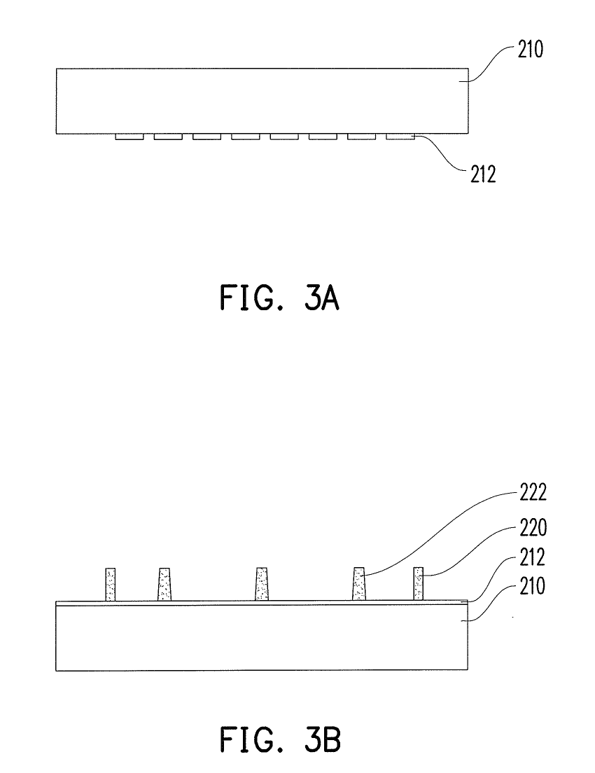

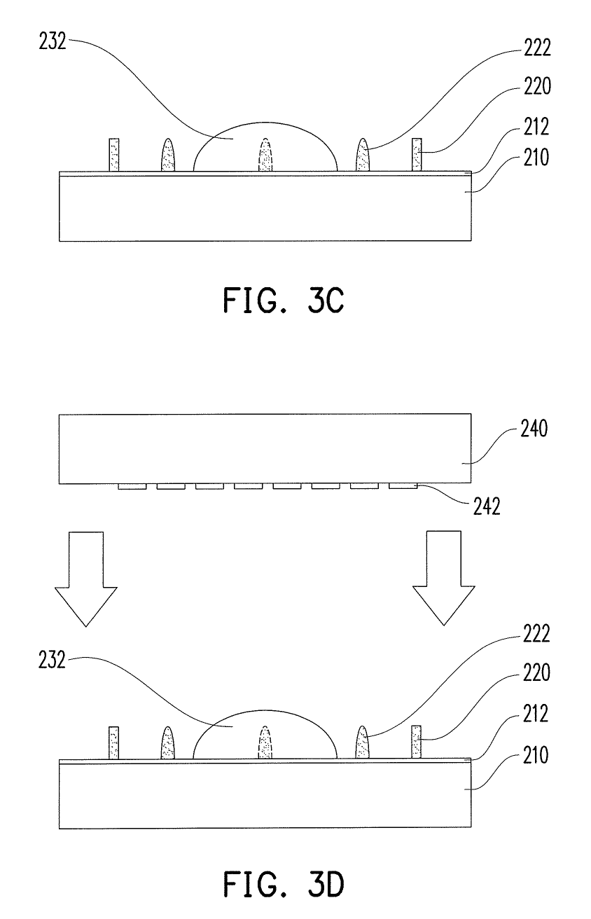

FIGS. 2A to 2D are three-dimensional views of the method of fabricating a touch panel according to an embodiment of the present invention, and FIGS. 3A to 3D are cross-sectional views of the method of fabricating a touch panel according to an embodiment of the present invention. The steps in FIGS. 2A to 2D are corresponding to those in FIGS. 3A-3D respectively. In other words, FIGS. 2A and 3A show the same step, and so forth, FIGS. 2B and 3B, 2C and 3C, 2D and 3D show same steps respectively. Referring to FIGS. 2A and 3A, a first substrate 210 having a first electrode layer 212 is provided. In this embodiment, the first substrate 210, for example, is a rigid substrate such as a glass substrate or a silicon substrate. The first electrode layer 212 is formed by a plurality of strip electrodes. In practice, the first electrode layer 212 may also be formed by electrode blocks in other geometrical shapes. The material of the first electrode layer 212 may be a conductive oxide, e.g., indium tin oxide (ITO) or indium zinc oxide (IZO).

Then, referring to FIGS. 2B and 3B, a sealant 220 is formed on the first substrate 210. The sealant 220 surrounds a periphery of the first substrate 210 to define a closed area P. The method of forming the sealant 220 includes a printing process, for example, a screen printing, ink jet printing, offset printing, relief printing, or gravure printing process. Moreover, the method of forming the sealant 220 may also be a dispensing process. In detail, the method of forming the sealant 220 includes forming an adhesive material such as a thermally curable adhesive, a light curable adhesive, or a UV-thermal curable adhesive on the periphery of the first substrate 210 through printing or the dispensing process. In the present embodiment, the thickness of the sealant 220 may thicker or thinner by adjusting the process according to different design requirements through dispersing appropriate size of spacers in the sealant 220.

When the sealant 220 is formed, a plurality of supports 222 may also be formed in the closed area P. In other words, the method of forming the supports 222 may be printing or the dispensing process. The distributions and positions of the supports 222 may vary according to different design requirements. For example, if the first substrate 210 has a large size, more supports 222 may be formed in the closed area P. If the first substrate 210 has a small size, less supports 222 or even no supports 222 will be disposed in the closed area P. In addition, the supports 222 and the sealant 220 may be fabricated at different time, and the supports 222 may be formed in the closed area P in other fabricating steps. Furthermore, the supports 222 are not limited to be fabricated through the printing or the dispensing process. In other embodiments, the method of fabricating the supports 222 may also be a spraying process or a photolithography process. In the spraying process, ball-shaped objects such as glass balls or silicon dioxide balls are dispersed in the closed area P. In the photolithography process, a patterned photoresist is formed in the closed area P to serve as supports 222.

Next, referring to FIGS. 2C and 3C, a liquid dielectric material 232 is dripped into the closed area P. The liquid dielectric layer 232, for example, is light curable or thermal curable liquid optical adhesive. Definitely, the liquid dielectric material 232 may also be other light curable or thermal curable materials. After the liquid dielectric material 232 in the closed area P is cured, the dielectric layer is formed in the closed area P (not shown in FIG. 2C). The liquid dielectric material 232 is dripped in the closed area P defined by the sealant 220, and the thickness of the sealant 220 may be adjusted arbitrarily, so the amount of the liquid dielectric material 232 may be changed accordingly. In other words, the liquid dielectric material 232 after being cured may have different thicknesses by dispersing appropriate size of spacers in the sealant 220, so the process design of the present embodiment is more flexible.

Next, referring to FIGS. 2D and 3D, a second substrate 240 is provided, and the first substrate 210 and the second substrate 240 are assembled and joined by the sealant 220. The second substrate 240 has a second electrode layer 242. Moreover, the material of the second substrate 240 for example is the same as that of the first substrate 210, and the second electrode layer 242 may be formed by a plurality of strip electrodes or by electrodes of other shapes. In practice, the strip electrodes extend on the first substrate 210 in a direction intersecting the extending direction of the strip electrodes on the second substrate 240. That is, partial areas of the first electrode layer 212 and the second electrode layer 242 are overlapped. The overlapped portion of the first electrode layer 212 and the second electrode layer 242, for example, forms a capacitor functioning as a sensing control area.

In detail, the method of assembling the first substrate 210 and the second substrate 240 is described as follows. The first substrate 21C and the second substrate 240 are first assembled. A curing process is performed to cure the sealant 220. At this time, in the course of assembling the first substrate 210 and the second substrate 240, the liquid dielectric material 232 dripped in the closed area P will fill the closed area P. In other words, the liquid dielectric material 232 is sealed in the closed area P by the sealant 220.

In practice, the curing process for curing the sealant 220 depends on the material of the sealant 220. If the material of the sealant 220 is a thermally curable adhesive, the method of curing the sealant 220 may be a thermal curing method. In other words, if the sealant 220 is made of a light curable material, the method of curing the sealant 220 for example is a light curing process. When the first substrate 210 and the second substrate 240 are assembled, the sealant 220 provides as supports. Therefore, even if the first substrate 210 and the second substrate 240 are rigid substrates such as glass substrates, bubbles will not be easily generated in this step. That is, the method of fabricating the present invention has a higher yield rate.

The supports 222 may be made of a same material as that of the sealant 220, so the supports 222 and the sealant 220 may be cured at the same time. If the supports 222 and the sealant 220 are made of different materials, the supports 222 may be cured after the supports 222 are formed in the closed area P, i.e., after the step as shown in FIGS. 2B and 3B. In addition, if the liquid dielectric material 232 has the light curability, and the sealant 220 is also made of a light curable material, the liquid dielectric material 232 and the sealant 220 may be cured in the same light curing process when the light curing process is adopted for curing. Similarly, if the liquid dielectric material 232 has the thermal curability, and the sealant 220 is also made of a thermal curable material, the liquid dielectric material 232 and the sealant 220 may be cured in the same thermal curing process. Definitely, the liquid dielectric material 232 and the sealant 220 may also be cured through different curing processes in different steps.

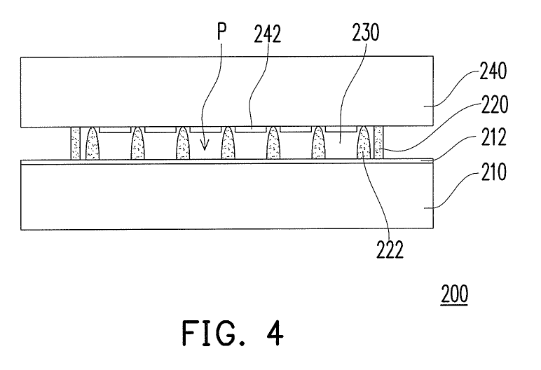

The touch panel fabricated through the above steps is shown in FIG. 4. Referring to FIG. 4, the touch panel 200 includes a first substrate 210, a sealant 220, a dielectric layer 230, and a second substrate 240. The first substrate 210 has a first electrode layer 212, and the second substrate 240 has a second electrode layer 242. The sealant 220 is disposed between the first substrate 210 and the second substrate 240, and defines a closed area P with the first substrate 210 and the second substrate 240. Meanwhile, the dielectric layer 230 is fabricated by curing the liquid dielectric material 232, and is disposed in the closed area P. Moreover, the touch panel 200 further includes a plurality of supports 222 disposed in the closed area P. However, in other embodiments, there is no the supports 222 to be disposed in the closed area P.

In the touch panel 200, the first substrate 210 and the second substrate 240 are assembled and joined by the sealant 220, so the distance between the first substrate 210 and the second substrate 240 is determined by the thickness of the sealant 220. If the size of the touch panel 200 becomes large, the distance between the first substrate 210 and the second substrate 240 of the touch panel 200 may remain fixed under the support of the supports 222. Therefore, in the touch panel 200 of the present invention, the distance between the first electrode layer 212 and the second electrode layer 242 is substantially the same in different areas, so the capacitance of the touch panel 200 remains consistent in different areas. That is, the touch panel 200 of the present invention has a good quality.

In addition, the touch panel 200 may adopt different designs. For example, the first electrode layer 212 may be disposed between the first substrate 210 and the dielectric layer 230 as shown in FIG. 4, or the first substrate 210 may be disposed between the first electrode layer 212 and tie dielectric layer 230. Similarly, the second electrode layer 242 may be disposed between the second substrate 240 and the dielectric layer 230, and in other embodiments, the second substrate 240 may be disposed between the second electrode layer 242 and the dielectric layer 230. In other words, the electrode layer (212 or 242) and the dielectric layer 230 may be disposed on the same side of the substrate (210 or 240), or on two opposite sides of the substrate (210 or 240).

To sum up, the touch panel and the fabricating method thereof of the present invention at least have the following advantages. In the method of fabricating a touch panel of the present invention, the bubbles will not be easily generated when the first substrate and the second substrate are assembled and joined by the sealant, so the touch panel of the present invention has a higher yield rate. In the present invention, the thickness of the sealant may vary according to different designs by dispersing appropriate size of spacers in the sealant 220, so the thickness of the dielectric layer may be changed in the touch panel of the present invention, such that the design of the touch panel become more flexible. In addition, in the present invention, a plurality of supports may be formed to maintain the distance between the two substrates, such that the touch panel has a good quality.

It will be apparent to persons of ordinary art in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of fabricating a touch panel, comprising:
providing a first substrate having a first electrode layer;
forming a sealant on the first substrate, wherein the sealant surrounds a periphery of the first substrate to define a closed area;
dripping a dielectric material into the closed area; and
providing a second substrate having a second electrode layer, wherein the first substrate and the second substrate are assembled and joined by the sealant, and the dielectric material fills the closed area to form a dielectric layer between the first substrate and the second substrate.

2. The method of fabricating a touch panel as claimed in claim 1, wherein a method of forming the sealant comprises a printing process.

3. The method of fabricating a touch panel as claimed in claim 2, wherein the printing process comprises screen printing, ink jet printing, offset printing, relief printing, or gravure printing.

4. The method of fabricating a touch panel as claimed in claim 1, wherein a method of forming the sealant comprises a dispensing process.

5. The method of fabricating a touch panel as claimed in claim 1, after the first substrate and the second substrate are assembled and joined, further comprising a curing process for curing the sealant.

6. The method of fabricating a touch panel as claimed in claim 5, wherein the curing process comprises thermal curing, light curing, UV curing, or a combination thereof.

7. The method of fabricating a touch panel as claimed in claim 1, wherein a method of forming the dielectric layer comprises curing the dielectric material in the closed area.

8. The method of fabricating a touch panel as claimed in claim 1, further comprising forming a plurality of supports on at least one of the first substrate and the second substrate, wherein the supports are disposed in the closed area.

9. The method of fabricating a touch panel as claimed in claim 8, wherein the sealant and the supports are simultaneously formed.

10. The method of fabricating a touch panel as claimed in claim 8, wherein a method of forming the supports comprises a spraying process for spraying a plurality of ball supports in the closed area.

11. The method of fabricating a touch panel as claimed in claim 8, wherein a method of forming the supports comprises a photolithography process.

12. The method of fabricating a touch panel as claimed in claim 8, wherein a method of forming the supports comprises a dispensing process.

13. The method of fabricating a touch panel as claimed in claim 8, wherein a method of forming the supports comprises a printing process.

14. The method of fabricating a touch panel as claimed in claim 13, wherein the printing process comprises screen printing, ink jet printing, offset printing, relief printing, or gravure printing.

15. A touch panel, comprising:
a first substrate, having a first electrode layer;
a second substrate, having a second electrode layer;
a sealant, disposed between the first substrate and the second substrate, and defining a closed area with the first substrate and the second substrate; and
a dielectric layer, disposed in the closed area.

16. The touch panel as claimed in claim 15, wherein the first electrode layer comprises a plurality of strip electrodes.

17. The touch panel as claimed in claim 15, wherein the second electrode layer comprises a plurality of strip electrodes.

18. The touch panel as claimed in claim 15, further comprising a plurality of supports disposed in the closed area.

19. The touch panel as claimed in claim 18, wherein the supports are a plurality of pillar supports.

20. The touch panel as claimed in claim 19, wherein a material of the pillar supports is one selected from among a photoresist material, a light curable material, and a thermally curable material.

21. The touch panel as claimed in claim 18, wherein the supports are a plurality of ball supports.

22. The touch panel as claimed in claim 21, wherein a material of the ball supports comprises silicon dioxide or glass.

23. The touch panel as claimed in claim 15, wherein the first substrate is disposed between the first electrode layer and the dielectric layer.

24. The touch panel as claimed in claim 15, wherein the first electrode layer is disposed between the first substrate and the dielectric layer.

25. The touch panel as claimed in claim 15, wherein the second substrate is disposed between the second electrode layer and the dielectric layer.

26. The touch panel as claimed in claim 15, wherein the second electrode layer is disposed between the second substrate and the dielectric layer.

27. The touch panel as claimed in claim 15, wherein a material of the dielectric layer is one selected from among a thermal curable material, a light curable material, and a UV-thermal curable material.
